(19) United States
(12) Patent Application Publication
(10) Pub. No.: US 2007/0153660 A1
(43) Pub. Date: Jul. 5, 2007

(54) METHOD AND SYSTEM FOR GENERATING LENGTH DEVIATION STATISTICS, AND METHOD AND SYSTEM FOR TUNING CONTROL PARAMETER OF OPTICAL STORAGE DEVICE USING THE SAME

(76) Inventor: Chih-Ching Yu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/306,586

(22) Filed: Jan. 3, 2006

(51) Int. Cl. G11B 7/0045

(52) U.S. Cl. 369/59.17; 369/59.11

(57) ABSTRACT

A method for generating length deviation statistics utilized for controlling operation of an optical storage device, includes: detecting a plurality of pattern lengths, each pattern length corresponding to data on an optical storage medium accessed by the optical storage device; and performing calculations according to the pattern lengths to generate length deviation statistics associated with the pattern lengths.

### BACKGROUND

The present invention relates to parameter tuning of an optical storage device, and more particularly, to methods and systems for generating length deviation statistics utilized for controlling operation of an optical storage device, and methods and systems for tuning at least one control parameter utilized for controlling operation of an optical storage device (e.g., a servo parameter or a write strategy parameter) by utilizing length deviation statistics.

As multimedia applications continue to progress, the demand for storing massive digital data has rapidly increased. As a result, high storage volume and compact size optical storage media such as Compact Discs (CDs) or Digital Versatile Discs (DVDs) are very popular, and optical storage devices such as CD drives or DVD drives have become standard accessories of personal computers, utilized for performing multimedia applications.

Within the optical storage devices, indexes such as bit error rate (BER) or data-to-clock jitter derived according to a reproduced signal (e.g. an RF signal) are typically utilized for estimating data quality. Scanning an index with respect to a certain control parameter such as a recording power of a writing process would be helpful for deriving the control parameter's optimized value corresponding to an extreme value of the index. According to the related art, however, the index utilized for this scanning operation usually varies slightly around the extreme value thereof with respect to the control parameter. Take the situation shown in FIG. 1 as an example. FIG. 1 illustrates distribution curves of respectively scanning the data-to-clock jitter and the BER with respect to the control parameter, where the distribution curves are aligned for being easily compared with each other. It is noted that the data-to-clock jitter and the BER vary slightly around their minimum values with respect to the control parameter, whose scanning resolution is relatively high. Therefore, the accuracy of the optimized value is low.

### SUMMARY

It is an objective of the claimed invention to provide methods and systems for generating length deviation statistics utilized for controlling operation of an optical storage device, and methods and systems for tuning at least one control parameter utilized for controlling operation of an optical storage device (e.g. a servo parameter or a write strategy parameter) by utilizing length deviation statistics.

An exemplary embodiment of a method for generating length deviation statistics utilized for controlling operation of an optical storage device comprises: detecting a plurality of pattern lengths, each pattern length corresponding to data on an optical storage medium accessed by the optical storage device; and performing calculations according to the pattern lengths to generate length deviation statistics associated with the pattern lengths.

An exemplary embodiment of a system for generating length deviation statistics utilized for controlling operation of an optical storage device comprises: a detector for detecting a plurality of pattern lengths, each pattern length corresponding to data on an optical storage medium accessed by the optical storage device; and a calculation module coupled to the detector, for performing calculations according to the pattern lengths to generate length deviation statistics associated with the pattern lengths.

An exemplary embodiment of a method for tuning at least one control parameter utilized for controlling operation of an optical storage device comprises: detecting a plurality of pattern lengths, each pattern length corresponding to data on an optical storage medium accessed by the optical storage device; performing calculations according to the pattern lengths to generate length deviation statistics associated with the pattern lengths; and utilizing the length deviation statistics for tuning the control parameter.

An exemplary embodiment of a system for tuning at least one control parameter utilized for controlling operation of an optical storage device comprises: a detector for detecting a plurality of pattern lengths, each pattern length corresponding to data on an optical storage medium accessed by the optical storage device; a calculation module coupled to the detector, for performing calculations according to the pattern lengths to generate length deviation statistics associated with the pattern lengths; and a controller coupled to the calculation module, the controller utilizing the length deviation statistics for tuning the control parameter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates distribution curves of respectively scanning the data-to-clock jitter and the bit error rate with respect to a control parameter, where the distribution curves are aligned for being easily compared with each other.

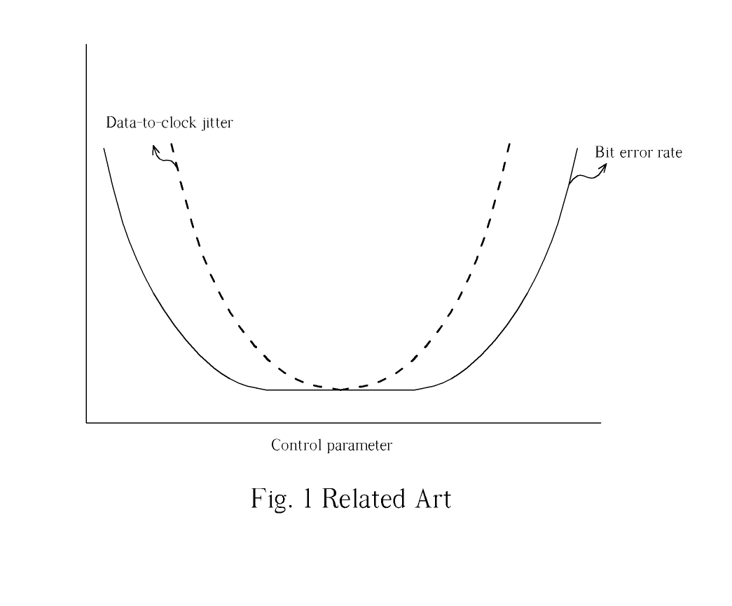

FIG. 2 is a block diagram of a system for tuning at least one control parameter utilized for controlling operation of an optical storage device according to one embodiment of the present invention.

FIG. 3 is a block diagram of a calculation module applicable to the system shown in FIG. 2 according to one embodiment of the present invention.

FIG. 4 is a flowchart of a method for tuning at least one control parameter utilized for controlling operation of an optical storage device according to one embodiment of the present invention.

FIG. 5 illustrates a distribution curve of scanning the length deviation statistics with respect to a control parameter in contrast to distribution curves of respectively scanning the data-to-clock jitter and the bit error rate with respect to the control parameter, where the distribution curves are aligned for being easily compared with one another.

FIG. 6 illustrates write strategy parameters that can be respectively tuned by utilizing the length deviation statistics according to different embodiments of the present invention.

FIG. 7 illustrates write strategy parameters that can be respectively tuned by utilizing the length deviation statistics according to different embodiments of the present invention.

FIG. 8 is a block diagram of a calculation module applicable to the system shown in FIG. 2 according to one embodiment of the present invention.

FIG. 9 is a flowchart of a method for tuning at least one control parameter utilized for controlling operation of an optical storage device according to one embodiment of the present invention.

FIG. 10 is a block diagram of a system for tuning at least one control parameter utilized for controlling operation of an optical storage device according to one embodiment of the present invention.

### DETAILED DESCRIPTION

The present invention provides systems for tuning at least one control parameter, which is utilized for controlling operation of an optical storage device, by utilizing length deviation statistics. According to a first aspect, one of the systems is a circuit for tuning the control parameter, where the circuit is positioned in the optical storage device. According to a second aspect, one of the systems is substantially the optical storage device itself. For simplicity, the first aspect is utilized in the following description. However, the second aspect is also applicable to the detailed embodiments.

In some embodiments, the control parameter tuned by the systems and corresponding methods provided by the present invention can be a servo parameter such as a defocus control parameter, a tilt control parameter, a tracking error (TE) offset control parameter, or a radio frequency (RF) boost control parameter. In other embodiments, the control parameter can be a write strategy parameter such as an edge delay, a pulse width, or a power level, where the power level can be a write power level, a bias power level, or an overdrive (OD) power level.

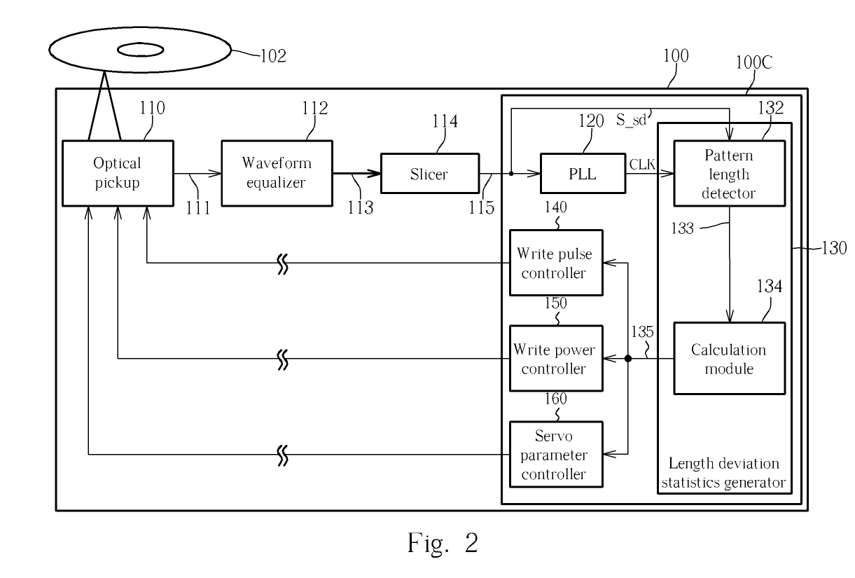

FIG. 2 illustrates a block diagram of a system 100C for tuning at least one control parameter utilized for controlling operation of an optical storage device 100 according to a first embodiment, where the system 100C is a circuit positioned in the optical storage device 100 accessing an optical storage medium 102. Please note that for simplicity, this embodiment is described as utilizing a CD-R disc as the optical storage medium 102 and as utilizing a CD drive as the optical storage device 100. Those skilled in the art should understand that other kinds of optical storage media such as DVD-R discs, DVD-RW discs, DVD+R discs, DVD+RW discs, DVD-RAM discs, HD-DVDs, or Blu-ray discs (BDs), and corresponding optical storage devices such as DVD drives, HD-DVD drives, or BD drives are also applicable according to other embodiments of the present invention.

As shown in FIG. 2, an optical pickup 110 of the optical storage device 100 reads data from the optical storage medium 102 to generate a raw RF signal 111 in a reading mode of the optical storage device 100. A waveform equalizer 112 of the optical storage device 100 equalizes the raw RF signal 111 to generate a reproduced signal, which is the RF signal 113 in the first embodiment. In addition, a slicer 114 of the optical storage device 100 slices the RF signal 113 to generate a sliced signal 115, which is the serial digital signal S_sd utilized by the system 100C of this embodiment. Operation principles of the optical pickup 110, the waveform equalizer 112, and the slicer 114 are well known in the art and therefore not described in detail here.

According to this embodiment, the system 100C comprises a phase-locked loop (PLL) 120, a length deviation statistics generator 130, and a plurality of controllers such as a write pulse controller 140, a write power controller 150, and a servo parameter controller 160, where the length deviation statistics generator 130 comprises a detector such as a pattern length detector 132 shown in FIG. 2, and further comprises a calculation module 134. Within the optical storage device 100, driving/control components (e.g. a modulator, a write pulse generator, a radiation source driver, actuators, etc.) along the lower paths respectively from the controllers (e.g. 140, 150, and 160) to the optical pickup 110 are not shown in FIG. 2 for simplicity. These omitted components along the lower paths in FIG. 2 are well known in the art and therefore not described in detail here.

The PLL 120 generates a reference clock CLK such as an EFM data clock according to the sliced signal 115 by locking the channel bit rate (1/T) of the sliced signal 115, where the period of the EFM data clock is considered to be 1T. Accordingly, the pattern length detector 132 derives EFM information carried by the sliced signal 115 according to the reference clock CLK, and detects a plurality of pattern lengths X, for example, X_{i,j} (where i=1, 2, . . . , n; and j=3T, 4T, . . . , 11T in this embodiment), where each pattern length X_{i,j} corresponds to data on the optical storage medium 102 with the index i representing the pattern length count and the index j representing a corresponding target length. Please note that the sliced signal 115 is typically a square wave having various intervals between rising edges and falling edges thereof and various intervals between falling edges and rising edges thereof. In this embodiment, the pattern length detector 132 measures intervals between rising edges and falling edges of the sliced signal 115 and/or intervals between falling edges and rising edges of the sliced signal 115 to determine the pattern lengths X mentioned above, where each interval corresponds to a pit or a land recorded on the optical storage medium 102. As a result, the pattern lengths X comprise pit lengths P corresponding to pits, and land lengths L corresponding to lands. Each of the pit lengths P represents a pit recorded along a groove on the optical storage medium 102, and each of the land lengths L represents a land along the groove.

In the first embodiment, the pattern lengths X derived from the sliced signal 115 are multiples of the clock period T and ranging from 3T to 11T in an ideal case of the CD-R disc. That is, a pattern length X can be 3T, 4T, . . . , 10T, or 11T. It is therefore reasonable that a reference signal for measuring the pattern lengths X (e.g. the reference clock CLK) has a period less than or equal to T. According to this embodiment, the reference signal inputted into the pattern length detector 132 is the reference clock CLK, where the period of the reference clock CLK is T. In a real case of the CD-R disc, the pattern lengths X carried by the output signal 133 of the pattern length detector 132 are usually not exact multiples of T. The calculation module 134 may perform calculations according to the pattern lengths X to generate length deviation statistics associated with the pattern lengths X, where the length deviation statistics are carried by an output signal 135 of the calculation module 134.

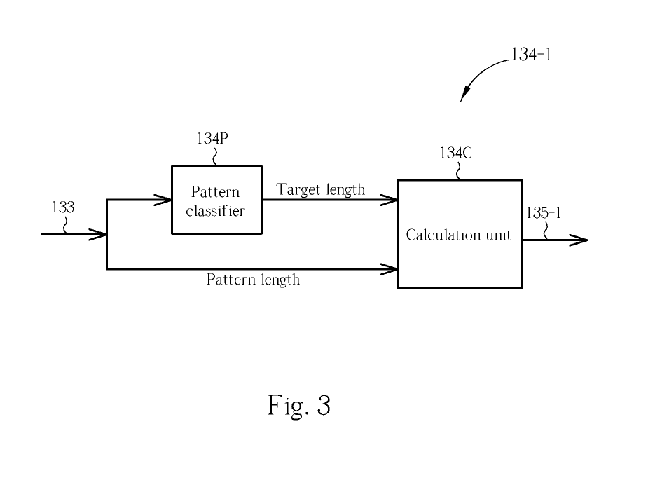

FIG. 3 illustrates a block diagram of a calculation module 134-1 applicable to the system 100C shown in FIG. 2 according to one embodiment of the present invention, where the calculation module 134-1 and an output signal 135-1 thereof respectively represent the calculation module 134 and the output signal 135 mentioned above. As shown in FIG. 3, the calculation module 134-1 comprises a pattern classifier 134P and a calculation unit 134C. The calculation unit 134C calculates a plurality of length deviations (X_{i,j}−X_target_{i,j}) (where i =1, 2, . . . , n; and j=3T, 4T, . . . , 11T in this embodiment), where each length deviation (X_{i,j}−X_target_{i,j}) is a difference between a pattern length X_{i,j} and a target length X_target_{i,j}, and the target length X_target_{i,j} of this embodiment is equal to the index j. The pattern classifier 134P classifies the pattern length X_{i,j} to determine the target length X_target_{i,j}, and the calculation unit 134C performs calculations according to the length deviations (X_{i,j}−X_target_{i,j}) to generate the length deviation statistics mentioned above.

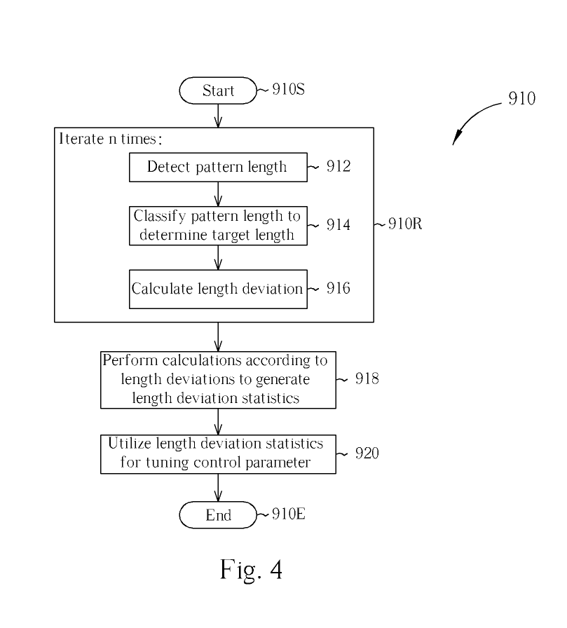

FIG. 4 is a flowchart of a method 910 for tuning at least one control parameter utilized for controlling operation of an optical storage device according to one embodiment of the present invention, where the method 910 can be implemented by utilizing the system 100C shown in FIG. 2 and the calculation module 134-1 shown in FIG. 3.

In Step 910R, under the control of a firmware code executed by a micro-processing unit (MPU) of the optical storage device 100, the system 100C iterates n times to execute Steps 912, 914, and 916, where the index i is varied from 1 to n as mentioned, and the index j is derived in Step 914 for each pattern length X_{i,j} and the corresponding target length X_target_{i,j} by the calculation module 134, and more particularly, by the pattern classifier 134P in this embodiment. Please note that according to the architecture shown in FIG. 2, at least two of the Steps 912, 914, and 916 can be executed at the same time for different values of the index i since the pattern length detector 132, the pattern classifier 134P, and the calculation unit 134C may continue to subsequently operate with respect to the index i.

In Step 912, the pattern length detector 132 detects the pattern length X_{i,j}.

In Step 914, the pattern classifier 134P classifies the pattern length X_{i,j} to determine the target length X_target_{i,j}. According to this embodiment, the pattern classifier 134P may determine the pattern length X_{i,j} to correspond to the target length X_target_{i,j} if the pattern length X_{i,j} satisfies the following inequality:
(j−0.5*T)≦X_{i,j}≦(j+0.5*T).

In Step 916, the calculation unit 134C calculates the length deviation (X_{i,j}−X_target_{i,j}).

In Step 918, the calculation unit 134C performs calculations according to the length deviations (X_{i,j}−X_target_{i,j}) to generate the length deviation statistics mentioned above. According to this embodiment, the length deviation statistics can be derived according to the following equation:

$$LDS = \sqrt{\frac{{\sum }_{i = 1}^{n} {( {X}_{i , j} - {X\_target}_{i , j} )}^{2}}{n}} ; \qquad ( 1 )$$

where LDS represents the length deviation statistics.

In Step 920, the MPU executing the firmware code utilizes the length deviation statistics for tuning the control parameter. According to this embodiment, the MPU executing the firmware code scans the length deviation statistics with respect to the control parameter to derive an extreme value of the distribution of the length deviation statistics, and tunes the control parameter according to the extreme value.

According to a variation of this embodiment, the calculation unit 134C calculates a square root of a result of summing the square values of the length deviations (X_{i,j}−X_target_{i,j}) to generate the length deviation statistics, since the result of summing these square values is proportional to the result of averaging the same square values.

According to another embodiment of the present invention, the length deviation statistics can be derived according to the following equation:

$$LDS = \frac{{\sum }_{i = 1}^{n} {\vert {X}_{i , j} - {X\_target}_{i , j} \vert}^{2}}{n} . \qquad ( 2 )$$

According to a variation of this embodiment, the calculation unit 134C sums the absolute values of the length deviations (X_{i,j}−X_target_{i,j}) to generate the length deviation statistics, since the result of summing these absolute values is proportional to the result of averaging the same absolute values.

According to another embodiment of the present invention, the MPU executing the firmware code mentioned above can be replaced by a controller, which is typically a hardware controller designed for executing a working flow such as the flowchart shown in FIG. 4.

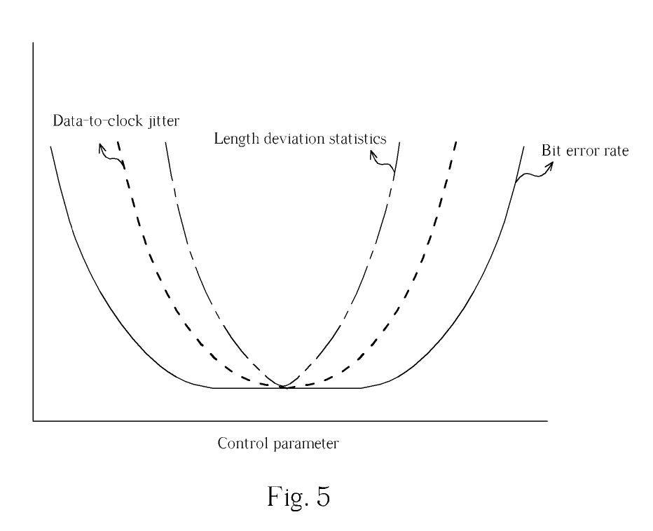

As shown in FIG. 5, a distribution curve of scanning the length deviation statistics with respect to the control parameter mentioned above is illustrated in contrast to distribution curves of respectively scanning the data-to-clock jitter and the bit error rate (BER) with respect to the control parameter, where the distribution curves are aligned so they can be easily compared with one another. It is noted that in contrast to an index according to the related art (e.g. the data-to-clock jitter or the BER), the length deviation statistics varies rapidly around the extreme value thereof with respect to the control parameter. Therefore, the accuracy of the optimized value derived from scanning the length deviation statistics with respect to the control parameter is higher than that according to the related art. That is, with a specific scanning resolution applied to the scanning operation whereof the optimized value determined by utilizing the data-to-clock jitter or the BER might drift around, the optimized value can be accurately determined by utilizing the length deviation statistics.

Please note that the control parameter shown in FIG. 5 can be a servo parameter such as the defocus control parameter, the tilt control parameter, the TE offset control parameter, or the RF boost control parameter mentioned above, or a write strategy parameter such as the edge delay, the pulse width, the write power level, the bias power level, or the OD power level mentioned above.

In a variation of the first embodiment, the pattern length detector 132 may only measure intervals between rising edges and falling edges of the sliced signal 115 to determine the pattern lengths X, and therefore, the pattern lengths X comprise pit lengths P. In another variation of the first embodiment, the pattern length detector 132 may only measure intervals between falling edges and rising edges of the sliced signal 115 to determine the pattern lengths X, and therefore, the pattern lengths X comprise land lengths L. Additionally, the sliced signal 115 of another embodiment of the present invention may carry EFM plus (EFM+) information (e.g. for an embodiment of DVD-R) or other information complying with a variation of the EFM/EFM+ specification.

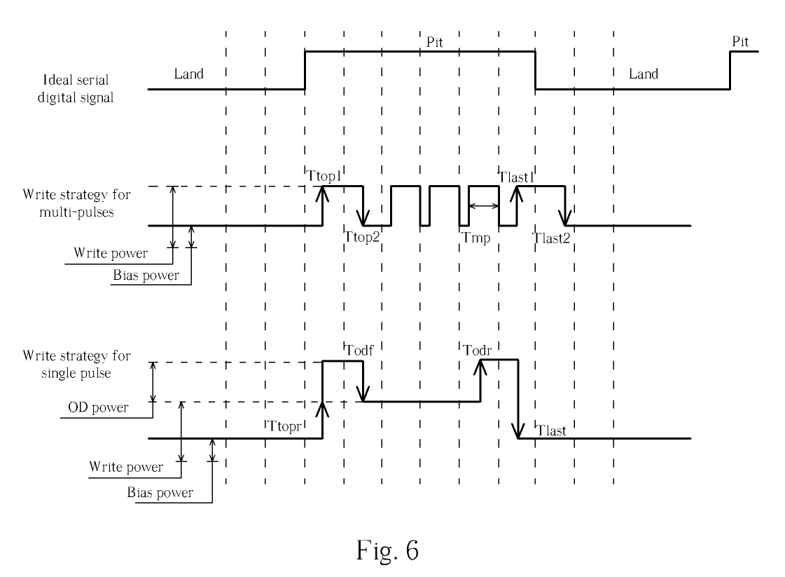

FIG. 6 illustrates the write strategy parameters that can be respectively tuned by utilizing the length deviation statistics according to different embodiments of the present invention, where the write strategy parameters shown in FIG. 6 are applicable to writing DVD-R discs, and the write strategy parameters of a write strategy for multi-pulses and a write strategy for a single pulse are respectively listed with respect to an ideal serial digital signal. The write strategy parameters Ttop1, Ttop2, Tlast1, Tlast2, Ttopr, Todf, Todr, and Tlast respectively correspond to certain edge delays (or edge shifts), and the write strategy parameter Tmp corresponds to a certain pulse width. In addition, the write strategy parameters such as the OD power, the write power, and the bias power shown in FIG. 6 respectively correspond to certain power levels.

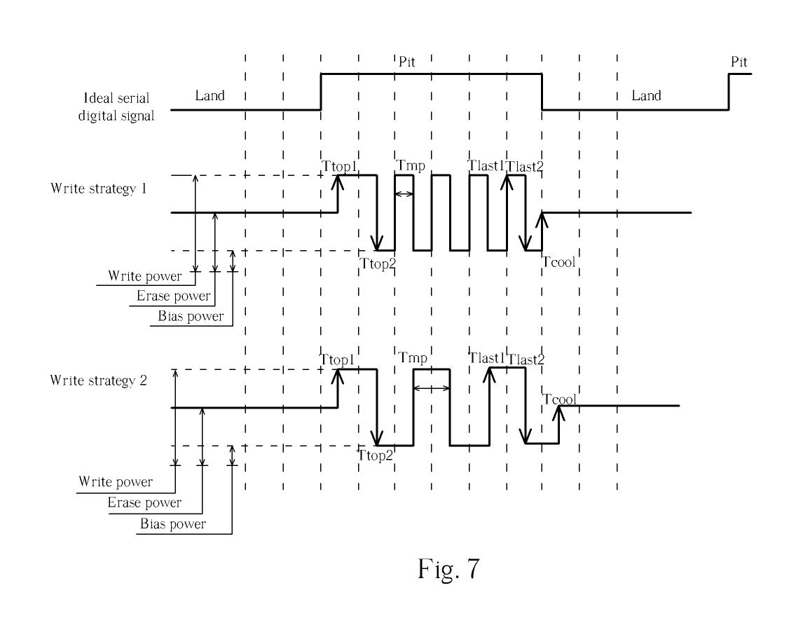

FIG. 7 illustrates the write strategy parameters that can be respectively tuned by utilizing the length deviation statistics according to different embodiments of the present invention, where the write strategy parameters shown in FIG. 7 are applicable to writing DVD-RW discs, and the write strategy parameters of a first write strategy (i.e. the “Write strategy 1” shown in FIG. 7) and a second write strategy (i.e. the “Write strategy 2” shown in FIG. 7) are listed with respect to an ideal serial digital signal. The write strategy parameters Ttop1, Ttop2, Tlast1, Tlast2, and Tcool respectively correspond to certain edge delays (or edge shifts), and the write strategy parameter Tmp corresponds to a certain pulse width. In addition, the write strategy parameters such as the write power and the bias power shown in FIG. 7 respectively correspond to certain power levels.

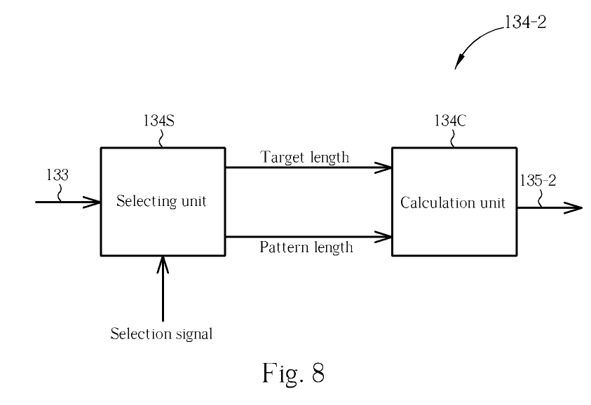

FIG. 8 illustrates a block diagram of a calculation module 134-2 applicable to the system 100C shown in FIG. 2 according to one embodiment of the present invention, where the calculation module 134-2 and an output signal 135-2 thereof respectively represent the calculation module 134 and the output signal 135 mentioned above. As shown in FIG. 8, the calculation module 134-2 comprises a selecting unit 134S and the calculation unit 134C mentioned above. The selecting unit 134S is capable of selecting pattern length(s) X_{i,j0} out of the pattern lengths X_{i,j} (where i=1, 2, . . . , n in this embodiment) according to a selection signal, where j0 represents a specific value within the range of the index j (e.g. a specific value out of 3T, 4T, . . . , 11T for CD-R/RW discs, or a specific value out of 3T, 4T, . . . , 11T, 14T for DVDS). In addition, the selecting unit 134S determines the target length X_target_{i,j0} by utilizing a predetermined value corresponding to the selection signal, for example, the value j0 in this embodiment.

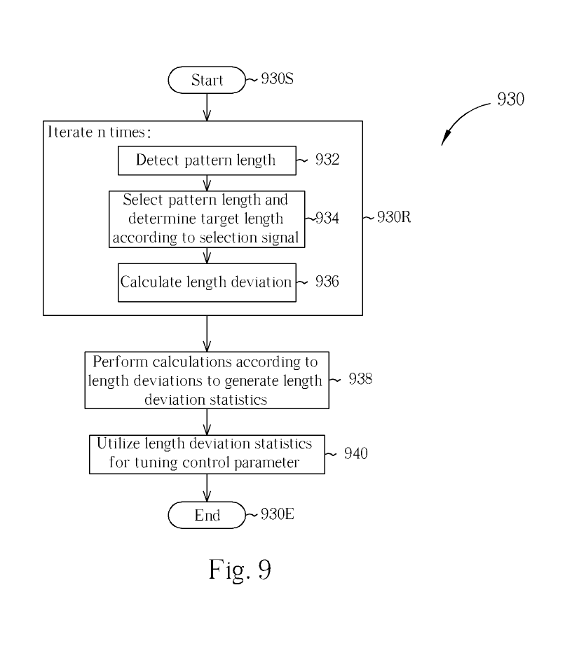

FIG. 9 is a flowchart of a method 930 for tuning at least one control parameter utilized for controlling operation of an optical storage device according to one embodiment of the present invention, where the method 930 can be implemented by utilizing the system 100C shown in FIG. 2 and the calculation module 134-2 shown in FIG. 8.

In Step 930R, under the control of another firmware code executed by the MPU of the optical storage device 100, the system 100C iterates n times to execute Steps 932, 934, and 936, where the index i is varied from 1 to n as mentioned. According to the architecture shown in FIG. 2, at least two of the Steps 932, 934, and 936 can be executed at the same time for different values of the index i as the pattern length detector 132, the selecting unit 134S, and the calculation unit 134C may continue to subsequently operate with respect to the index i, respectively.

In Step 932, the pattern length detector 132 detects the pattern length X_{i,j}.

In Step 934, the selecting unit 134S selects the pattern length X_{i,j0} according to the selection signal mentioned above, and determines the target length X_target_{i,j} to be the predetermined value j0 mentioned above. According to this embodiment, the selecting unit 134S may determine the pattern length X_{i,j} to be the pattern length X_{i,j0} if the pattern length X_{i,j} satisfies the following inequality:
(j0−0.5*T)≦X_{i,j}≦(j0+0.5*T).

As a result, if the above equation is satisfied, the selecting unit 134S outputs the pattern length X_{i,j} as the pattern length X_{i,j0}; otherwise, the selecting unit 134S discards the pattern length X_{i,j}. The selecting unit 134S may continue to output j0 as the X_target_{i,j0} as long as the selection signal indicates that j0 is the selected value of the index j.

In Step 936, the calculation unit 134C calculates the length deviation (X_{i,j0}−X_target_{i,j0}).

In Step 938, the calculation unit 134C performs calculations according to the length deviations (X_{i,j0}−X_target_{i,j0}) to generate the length deviation statistics mentioned above. According to this embodiment, the length deviation statistics can be derived according to the following equation:

$$LDS ( j 0 ) = \sqrt{\frac{{\sum }_{i = 1}^{n} {( {X}_{i , j 0} - {X\_target}_{i , j 0} )}^{2}}{n}} . \qquad ( 3 )$$

In Step 940, the MPU executing the firmware code utilizes the length deviation statistics for tuning the control parameter. Similarly, the MPU executing the firmware code scans the length deviation statistics with respect to the control parameter to derive an extreme value of the distribution of the length deviation statistics, and tunes the control parameter according to the extreme value.

According to a variation of this embodiment, the calculation unit 134C calculates a square root of a result of summing the square values of the length deviations (X_{i,j0}−X_target_{i,j0}) to generate the length deviation statistics, since the result of summing these square values is proportional to the result of averaging the same square values.

According to another embodiment of the present invention, the length deviation statistics can be derived according to the following equation:

$$LDS ( j 0 ) = \frac{{\sum }_{i = 1}^{n} \vert {X}_{i , j 0} - {X\_target}_{i , j 0} \vert}{n} . \qquad ( 4 )$$

According to a variation of this embodiment, the calculation unit 134C sums the absolute values of the length deviations (X_{i,j0}−X_target_{i,j0}) to generate the length deviation statistics, as the result of summing these absolute values is proportional to the result of averaging the same absolute values.

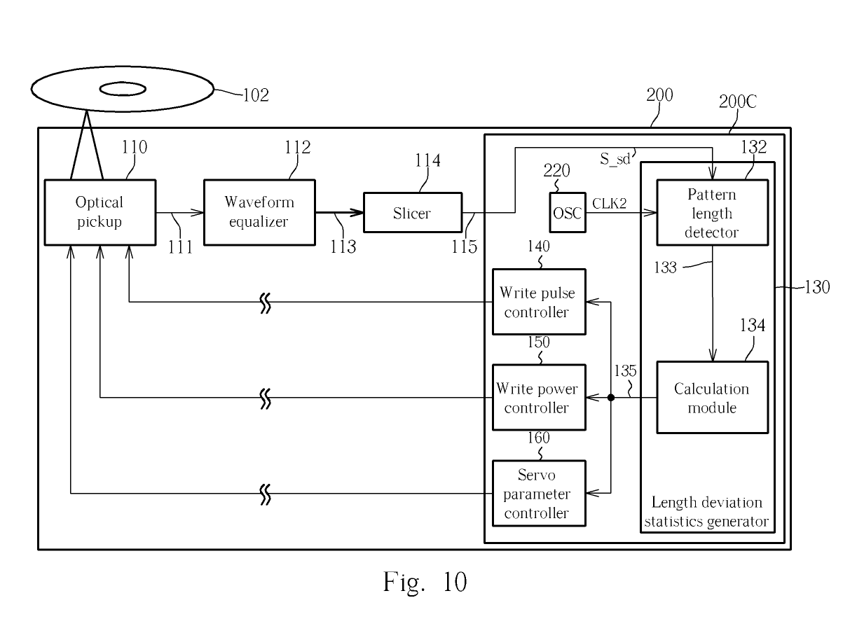

FIG. 10 is a block diagram of a system 200C for tuning at least one control parameter utilized for controlling operation of an optical storage device 200 according to a second embodiment of the present invention. The second embodiment is similar to the first embodiment, where the differences are described as follows. As the reference signal inputted into the pattern length detector 130 is a reference clock CLK2 generated by an oscillator 220, a PLL such as the PLL 120 mentioned above is not required to implement the second embodiment. It is also not necessary for the frequency of the reference clock CLK2 to be equal to the frequency of the data clock of the serial digital signal S_sd.

It should be noted that the present invention could be implemented by means of hardware including a plurality of distinct elements, or by means of a suitably programmed computer. In the system claims detailing a plurality of means, several means can be implemented by the same hardware or software device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for tuning at least one control parameter utilized for controlling operation of an optical storage device, comprising:
detecting a plurality of pattern lengths, each pattern length corresponding to data on an optical storage medium accessed by the optical storage device;
performing calculations according to the pattern lengths to generate length deviation statistics associated with the pattern lengths; and
utilizing the length deviation statistics for tuning the control parameter.

2. The method of claim 1, wherein the step of detecting the pattern lengths further comprises:
detecting the pattern lengths according to a reproduced signal generated by the optical storage device accessing the optical storage medium.

3. The method of claim 2, further comprising:
slicing the reproduced signal to generate a sliced signal;
wherein the step of detecting the pattern lengths further comprises detecting the pattern lengths according to the sliced signal.

4. The method of claim 3, wherein the step of detecting the pattern lengths further comprises:
detecting intervals between rising edges and falling edges of the sliced signal and/or intervals between falling edges and rising edges of the sliced signal to determine the pattern lengths, wherein each interval corresponds to a pit or a land.

5. The method of claim 1, wherein the step of performing calculations according to the pattern lengths further comprises:
calculating a plurality of length deviations, each length deviation being a difference between a pattern length and a target length; and
performing calculations according to the length deviations to generate the length deviation statistics.

6. The method of claim 5, wherein the step of performing calculations according to the pattern lengths further comprises:
classifying the pattern length to determine the target length.

7. The method of claim 5, wherein the step of performing calculations according to the pattern lengths further comprises:
selecting the pattern length out of the pattern lengths according to a selection signal; and
determining the target length by utilizing a predetermined value corresponding to the selection signal.

8. The method of claim 5, wherein the step of performing calculations according to the length deviations further comprises:
calculating a square root of a result of summing or averaging square values of the length deviations to generate the length deviation statistics.

9. The method of claim 5, wherein the step of performing calculations according to the length deviations further comprises:
summing or averaging absolute values of the length deviations to generate the length deviation statistics.

10. The method of claim 1, wherein the step of utilizing the length deviation statistics further comprises:
scanning the length deviation statistics with respect to the control parameter to derive an extreme value of the distribution of the length deviation statistics; and
tuning the control parameter according to the extreme value.

11. The method of claim 1, wherein the control parameter is a servo parameter or a write strategy parameter.

12. A system for tuning at least one control parameter utilized for controlling operation of an optical storage device, comprising:
a detector for detecting a plurality of pattern lengths, each pattern length corresponding to data on an optical storage medium accessed by the optical storage device;
a calculation module coupled to the detector, for performing calculations according to the pattern lengths to generate length deviation statistics associated with the pattern lengths; and
a controller coupled to the calculation module, the controller utilizing the length deviation statistics for tuning the control parameter.

13. The system of claim 12, wherein the detector detects the pattern lengths according to a reproduced signal generated by the optical storage device accessing the optical storage medium.

14. The system of claim 13, further comprising:
a slicer for slicing the reproduced signal to generate a sliced signal;
wherein the detector detects the pattern lengths according to the sliced signal.

15. The system of claim 14, wherein the detector detects intervals between rising edges and falling edges of the sliced signal and/or intervals between falling edges and rising edges of the sliced signal to determine the pattern lengths, and each interval corresponds to a pit or a land.

16. The system of claim 12, wherein the calculation module comprises:
a calculation unit for calculating a plurality of length deviations, each length deviation being a difference between a pattern length and a target length, the calculation unit performing calculations according to the length deviations to generate the length deviation statistics.

17. The system of claim 16, wherein the calculation module further comprises:
a pattern classifier coupled between the detector and the calculation unit, for classifying the pattern length to determine the target length.

18. The system of claim 16, wherein the calculation module further comprises:
a selecting unit coupled between the detector and the calculation unit, for selecting the pattern length out of the pattern lengths according to a selection signal, and determining the target length by utilizing a predetermined value corresponding to the selection signal.

19. The system of claim 16, wherein the calculation unit calculates a square root of a result of summing or averaging square values of the length deviations to generate the length deviation statistics.

20. The system of claim 16, wherein the calculation unit sums or averages absolute values of the length deviations to generate the length deviation statistics.

21. The system of claim 12, wherein the controller scans the length deviation statistics with respect to the control parameter to derive an extreme value of the distribution of the length deviation statistics, and tunes the control parameter according to the extreme value.

22. The system of claim 12, wherein the control parameter is a servo parameter or a write strategy parameter.

23. A method for generating length deviation statistics utilized for controlling operation of an optical storage device, comprising:
detecting a plurality of pattern lengths, each pattern length corresponding to data on an optical storage medium accessed by the optical storage device; and
performing calculations according to the pattern lengths to generate length deviation statistics associated with the pattern lengths.

24. The method of claim 23, wherein the step of detecting the pattern lengths further comprises:
detecting the pattern lengths according to a reproduced signal generated by the optical storage device accessing the optical storage medium.

25. The method of claim 24, further comprising:
slicing the reproduced signal to generate a sliced signal;
wherein the step of detecting the pattern lengths further comprises detecting the pattern lengths according to the sliced signal.

26. The method of claim 25, wherein the step of detecting the pattern lengths further comprises:
detecting intervals between rising edges and falling edges of the sliced signal and/or intervals between falling edges and rising edges of the sliced signal to determine the pattern lengths, wherein each interval corresponds to a pit or a land.

27. The method of claim 23, wherein the step of performing calculations according to the pattern lengths further comprises:
calculating a plurality of length deviations, each length deviation being a difference between a pattern length and a target length; and
performing calculations according to the length deviations to generate the length deviation statistics.

28. The method of claim 27, wherein the step of performing calculations according to the pattern lengths further comprises:
classifying the pattern length to determine the target length.

29. The method of claim 27, wherein the step of performing calculations according to the pattern lengths further comprises:
selecting the pattern length out of the pattern lengths according to a selection signal; and
determining the target length by utilizing a predetermined value corresponding to the selection signal.

30. The method of claim 27, wherein the step of performing calculations according to the length deviations further comprises:
calculating a square root of a result of summing or averaging square values of the length deviations to generate the length deviation statistics.

31. The method of claim 27, wherein the step of performing calculations according to the length deviations further comprises:
summing or averaging absolute values of the length deviations to generate the length deviation statistics.

32. A system for generating length deviation statistics utilized for controlling operation of an optical storage device, comprising:
a detector for detecting a plurality of pattern lengths, each pattern length corresponding to data on an optical storage medium accessed by the optical storage device; and
a calculation module coupled to the detector, for performing calculations according to the pattern lengths to generate length deviation statistics associated with the pattern lengths.

33. The system of claim 32, wherein the detector detects the pattern lengths according to a reproduced signal generated by the optical storage device accessing the optical storage medium.

34. The system of claim 33, further comprising:
a slicer for slicing the reproduced signal to generate a sliced signal;
wherein the detector detects the pattern lengths according to the sliced signal.

35. The system of claim 34, wherein the detector detects intervals between rising edges and falling edges of the sliced signal and/or intervals between falling edges and rising edges of the sliced signal to determine the pattern lengths, and each interval corresponds to a pit or a land.

36. The system of claim 32, wherein the calculation module comprises:
a calculation unit for calculating a plurality of length deviations, each length deviation being a difference between a pattern length and a target length, the calculation unit performing calculations according to the length deviations to generate the length deviation statistics.

37. The system of claim 36, wherein the calculation module further comprises:
a pattern classifier coupled between the detector and the calculation unit, for classifying the pattern length to determine the target length.

38. The system of claim 36, wherein the calculation module further comprises:
a selecting unit coupled between the detector and the calculation unit, for selecting the pattern length out of the pattern lengths according to a selection signal, and determining the target length by utilizing a predetermined value corresponding to the selection signal.

39. The system of claim 36, wherein the calculation unit calculates a square root of a result of summing or averaging square values of the length deviations to generate the length deviation statistics.

40. The system of claim 36, wherein the calculation unit sums or averages absolute values of the length deviations to generate the length deviation statistics.
